(19) United States
(12) Patent Application Publication
(10) Pub. No.: US 2014/0250030 A1
(43) Pub. Date: Sep. 4, 2014

(54) METHOD AND APPARATUS USING DEBT OR EQUITY FOR MAKING FINANCIAL TRANSACTIONS ECONOMIC

(71) Applicant: Vincent Paul Iannazzo, New York, NY (US)

(72) Inventor: Vincent Paul Iannazzo, New York, NY (US)

(21) Appl. No.: 14/097,206

(22) Filed: Dec. 4, 2013

Related U.S. Application Data
(60) Provisional application No. 61/771,749, filed on Mar. 1, 2013.

(51) Int. Cl. G06Q 40/06

(52) U.S. Cl. CPC G06Q 40/06
USPC 705/36 R

(57) ABSTRACT

A business method and system work to create an observable, verifiable and tangible result that can prevent the default of financial transactions by creating a separate income generating Private Equity Portfolio Asset Base that can be financially relied upon prior to a financial default. The self-insured, income generating Private Equity Portfolio is created contemporaneously by the select equity creator plus (SECP) at the time of the underlying transaction's closing, providing contemporaneous liquidity upon the execution of the underlying transaction. Once the underlying transaction is secured, the additional value created by the SECP, vis-à-vis the Private Equity Portfolio, may be used for other financial purposes unrelated to the original underlying transaction. The user of the SECP has a direct and additional financial benefit from the Private Equity Portfolio Asset Base in tandem with the counterparty to the financial transaction.

### CROSS-REFERENCE TO RELATED APPLICATION

This application claims the benefit of priority of U.S. provisional application No. 61/771,749, filed Mar. 1, 2013, the contents of which are herein incorporated by reference.

### BACKGROUND OF THE INVENTION

The present invention relates to financial methods and apparatus and more particularly, to methods and apparatus using debt or equity to make financial transactions economic.

Traditional Cross Collateralization does not provide the flexibility needed in a volatile economic environment and, as a result, it may be restrained or deficient from preventing a default.

Synthetic Derivatives, Letters of Credit, Bank Guarantees and Traditional Self-Insurance Mechanisms do not provide financial flexibility. All of the mentioned do not create any income generating private equity portfolios at the time of closing the transaction.

As can be seen, there is a need for a method and apparatus for creating a private equity portfolio, using debt or equity, that can generate income at the time of a transaction's closing.

### SUMMARY OF THE INVENTION

In one aspect of the present invention, a computer assisted method for preventing default of a financial transaction comprises computationally analyzing one or more investment candidates to determine one or more suitable investments; computing the Net Present Value of the one or more suitable investments; and creating contemporaneous liquidity upon execution of the financial transaction by vesting the one or more suitable investments into an Irrevocable Master Trust that supports the financial transaction, wherein the Net Present Value of the one or more suitable investments created in the Irrevocable Master Trust are separate from the financial transaction and have more value than the financial transaction.

In another aspect of the present invention, a financial structure comprises an underlying financial transaction; and an Irrevocable Master Trust created contemporaneously upon execution of the underlying financial transaction to support the underlying financial transaction.

In a further aspect of the present invention, a system for preventing default of a financial transaction comprises a data storage device; a control program; and a data processor, wherein the control program includes software configured for computationally analyzing one or more investment candidates to determine one or more suitable investments; computing the Net Present Value of the one or more suitable investments; and creating contemporaneous liquidity upon execution of the financial transaction by vesting the one or more suitable investments into an Irrevocable Master Trust that supports the financial transaction, wherein the net present value of the one or more suitable investments created in the irrevocable master trust are separate from the financial transaction and have more value than the financial transaction.

These and other features, aspects and advantages of the present invention will become better understood with reference to the following drawings, description and claims.

### BRIEF DESCRIPTION OF THE DRAWINGS

FIG. 1 is a schematic representation illustrating core functional components of a system constructed in accordance with exemplary embodiments of the present invention;

FIG. 2 is a flow diagram that represents the operational steps employed by a system and method according to an exemplary embodiment of the present invention;

FIG. 3 is a schematic representation illustrating a self-insurance component derived from a master irrevocable trust and further illustrating a method for adding value to the master irrevocable trust during the course of its lifetime; and

FIG. 4 is a process flow diagram illustrating the operational steps employed by an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a business method and apparatus that work to create an observable, verifiable and tangible result that can prevent the default of financial transactions by creating a separate income generating Private Equity Portfolio Asset Base that can be financially relied upon prior to a financial default. The self-insured, income generating Private Equity Portfolio is created contemporaneously by the Select Equity Creator Plus (SECP) at the time of the underlying transaction's closing, providing contemporaneous liquidity upon the execution of the underlying transaction. Once the underlying transaction is secured, the additional value created by SECP, vis-a-vis the Bespoke Private Equity Portfolio, may be used for other financial purposes unrelated to the original underlying transaction. What is important to note is that the user of SECP has a direct and additional financial benefit from the Private Equity Portfolio Asset Base in tandem with the counterparty to the financial transaction at the time of execution. Additionally, subsequent to the satisfaction and or completion of the underlying transaction, the SECP user still retains the financial benefits of the Private Equity Portfolio.

The Business Method/SECP of the present invention can prevent a financial default by drawing upon a newly created asset base in a Time Determinate Irrevocable Master Trust or by way of the Irrevocable Sub-Trust (IST) that provides the Self-Insured Component (SIC) of the Invention. The IST may be created contemporaneously at the closing of the underlying transaction. The IST provides the Business Method/SECP with a greater degree of flexibility to maintain the unencumbered financial integrity of the IMT at the inception of the underlying transaction.

Embodiments of the present invention can be utilized in the real estate industry, sustainable and renewable energy projects, university research projects, medical research projects, humanitarian projects, animal rights projects, infrastructure development projects, government projects, non-government projects, mining and extraction projects, agricultural projects, water projects, corporate acquisitions, and the like. Aspects of the present invention can be used for non-economic transactions, including, for example, the purchase of non-income producing asset classes such as non-performing debt, art collections, grant creation and philanthropic endeavors.

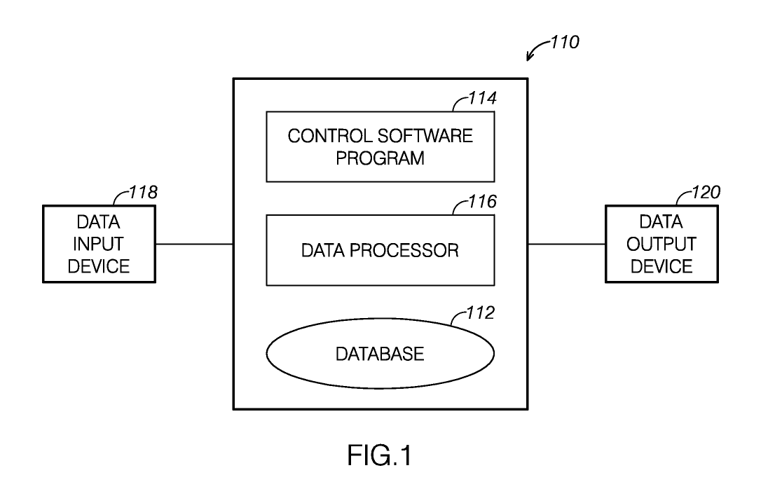

Referring to FIG. 1, functional components of an exemplary system developed in accordance with embodiments of the present invention are shown. System 110 includes a data storage device or database (112), a control program (114) which is operable to integrate the components of the System 110, and a data processor (116). A data input device (118) can be used to provide input into System 110. The data input device (118) can include a keyboard, mouse, touch screen, voice recognition, and the like. A data output device (120) can be used to allow a user to view data from System 110. The data output device (120) can be a video monitor, an audio output, or the like. While the components are indicated in a single enclosure in FIG. 1, it should be understood that such components can include one or more of any of the components. For example, the database (112) can include multiple database sources.

Further, it should be understood that one or more of the components of System 110 may have multiple uses. For example, the data input device (118) may be combined with the data output device (120). Also, one or more of the components may be hosted, such as via cloud computing on a mainframe computing system. Accordingly, System 110 may be integrated with other systems, such as a program maintained by an outside software company, such as Bloomberg Services, for example.

Those skilled in the art will readily ascertain that a system in accordance with some embodiments of the present invention may include various computer and network related software and hardware, specifically, programs, operating systems, memory storage devices, data input and output devices, computer processors, servers with links to data communication systems, wireless or wired, such as those that form a local or wide area network, such as Bloomberg Monitoring and Subscription Service.

Those skilled in the art will further appreciate that specific types of communication networks and devices, software and hardware are not vital to the full implementation of various embodiments described herein or other embodiments within the scope of the present Invention.

Further, it should be understood that the type of communication network, devices, software and hardware may also vary predicated upon rapid advances in technology that are ongoing in the financial data community. Therefore, the precise software and hardware configuration of the various embodiments may be permutations of the embodiments of the present invention while still remaining within the scope, purview and spirit of the present invention.

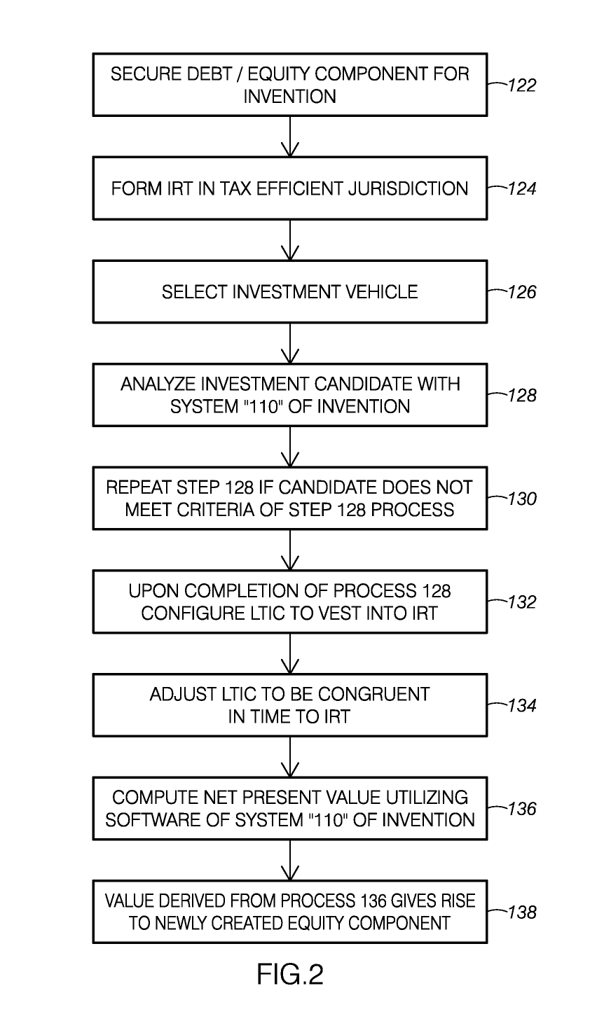

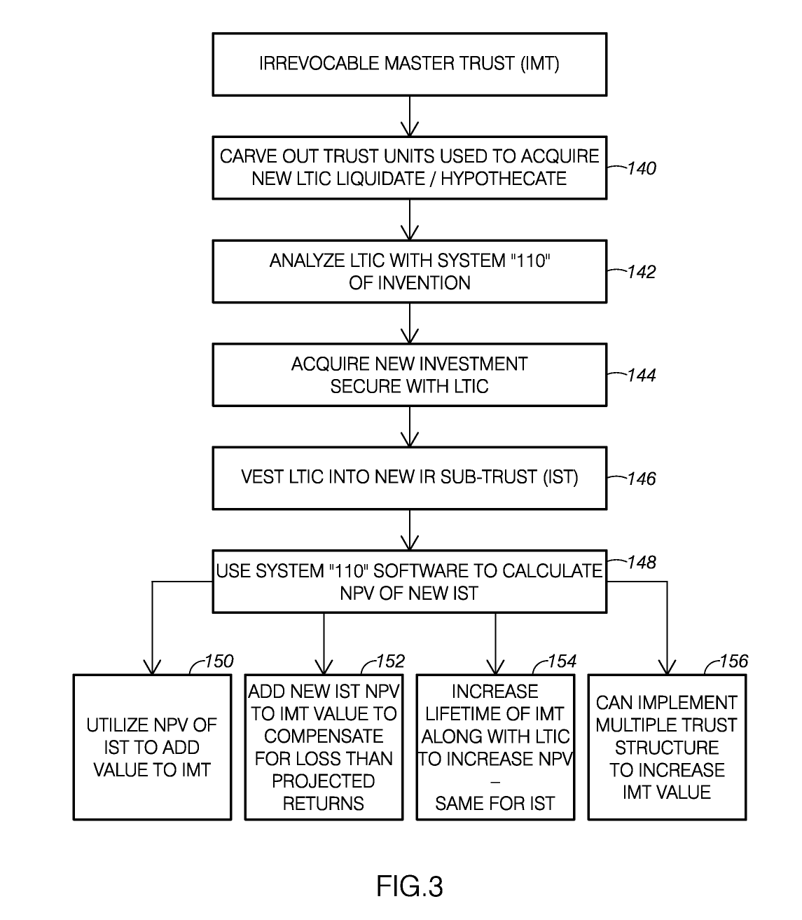

Referring now to FIGS. 2 and 3, the term IMT, refers to an Irrevocable Master Trust, and LTIC refers to a Long Term Investment Contract. In step 122, debt and/or equity are secured. In step 124, an Irrevocable Master Trust (IMT) can be formed. In some embodiments, a tax efficient jurisdiction may be chosen for the formation of the IMT. In step 126, the investment vehicle is chosen, as better described below. In step 128, the investment candidate can be analyzed with System 110 described above and, as shown in step 130, if the candidate investment does not meet predetermined criteria, step 126 and 128 are repeated until such a suitable candidate investment is found. In step 132, upon completion of the selection of the investment vehicle, a Long Term Investment Contract (LTIC) can be configured to vest into the IMT. In step 134, the LTIC can be adjusted to be congruent in time to the IMT. In step 136, the net present value can be computed utilizing software of System 110 of the present invention. In step 138, the value derived from step 136 gives rise to a newly created equity component.

In should be noted, that the net present value element of the invention can be computed by System 110 using various types of software, such as Microsoft Excel Software. The software can utilize the discount rate and a series of future payments (negative values) and income (positive values). Accordingly, an explanation of the computed net present value is demonstrated by means of an example utilizing System 110. First, input the data of the investment's discount rate and the cash flows it will return each year into System 110. The discount rate represents the annual return one could earn on a similar investment with similar risk. For demonstration, assume a business is considering investing in new programming software that will generate cash flows of $1,200, $1,100, and $1,000 in the first through third years, respectively. For this explanation, the discount rate will be 8%. Each cash flow, the year they will be achieved, and the discount rate as a decimal are entered into the following formula utilizing System 110: cash flow/[(1+discount rate)̂year]. A different formula can be used for each contractually secured cash flow. In this example, the formulas are $1,200/[(1+0.08)̂1], $1,100/[(1+0.08)̂2] and $1,000/[(1+0.08)̂3] for the first through third years, respectively. The numbers in parentheses of the first formula are input into System 110 and raised to the power of the exponent. The numerator is then input into System 110 by that result to compute the present value of the first year's cash flow. Then, the formula for each additional year's cash flow can be computed by System 110. In this demonstration, one would input 1 to 0.08 to get 1.08 and raise this value (1.08) by the first power to obtain 1.08. The numerator ($1,200) is computationally divided System 110 by 1.08 to get a present value of the first year's cash flow of $1,111. The other two formulas are computed by System 110 to obtain the present values of $943 and $794 for the second and third year's cash flows, respectively.

Next, the present value of each cash flow is computed by System 110 to get the entire present value of the investment cash flows. In this demonstration, $1,111, $943 and $794 are input into System 110 for a present value of $2,848. Finally, the up-front cost is input into System 110 along with the entire present value of its cash flows to compute its net present value. In closing, the demonstration, one can assume the up-front cost is $500. Thus, inputting the data values of $500 and $2,848 into System 110, one obtains a NPV of $2,348. The foregoing substantiates vis-a-vis System 110 that you can expect the investment will generate a profit of $2,348. In accordance with system 110, the projected and secured NPV of the investment is vested into a Special Purpose Vehicle (SPV) to create the portfolio of Private Equities of the Business Method/SECP of the invention.

Referring to FIG. 3, in step 140, trust units can be carved out and used to acquire a new LTIC from the IMT/IST. In step 142, the LTIC can be analyzed with the system of the present invention. In step 144, a new investment can be secured with the LTIC and, in step 146; the LTIC can be vested into a new Irrevocable Sub-Trust (IST). The software of the System 110, described above, can be used to compute the net present value of the newly formed IST in step 148. In step 150, the net present value of the IST can be used to add value to the master trust. In step 152, the new IST net present value can be added to the master trust to compensate for less than projected returns. In step 154, the lifetime of the IMT, along with the LTIC, can be increased to increase the net present value. In step 156, a multiple trust structure can be used to increase the irrevocable master trust value.

The Business Method/SECP of the invention create bespoke private equities that are separate from the underlying financial transaction. The equities support the financial transaction since they are a separate asset class within the structure of the SECP. This directly creates concrete, useful and tangible benefits to all of the parties to the financial transaction. The Net Present Value (NPV) is the financial methodology utilized by System 110 that causes the capitalization of the IMT and IST that gives rise to the bespoke private equity portfolios.

Since the Net Present Value (NPV) of income generating equities created in a Time Determinate Irrevocable Master Trust is separate from the underlying transaction, they have significantly more value than the underlying transaction. Accordingly, the asset(s) acquired in the underlying transaction do not have to revert back to the seller or funding financial institution through foreclosure because of the added created value vested in the bespoke private equity portfolio can be relied upon by the financial institution funding the transaction or seller of the asset(s).

Furthermore, in the event of an anticipated default of the underlying transaction, the separate equity portfolio vested in the Time Determinate Irrevocable Trust, can be utilized to satisfy the debt vis-à-vis the hypothecation or sale of the Trust Assets. Therefore, the financial burden upon the underwriting entity or guarantor of the underlying financial transaction is made whole. To illustrate: the underlying transaction value is X. The value of the Time Determinate Irrevocable Trust is 3X. Both the former and latter values are created at the time of the closing of the financial transaction using the prescribed Business Method/SECP.

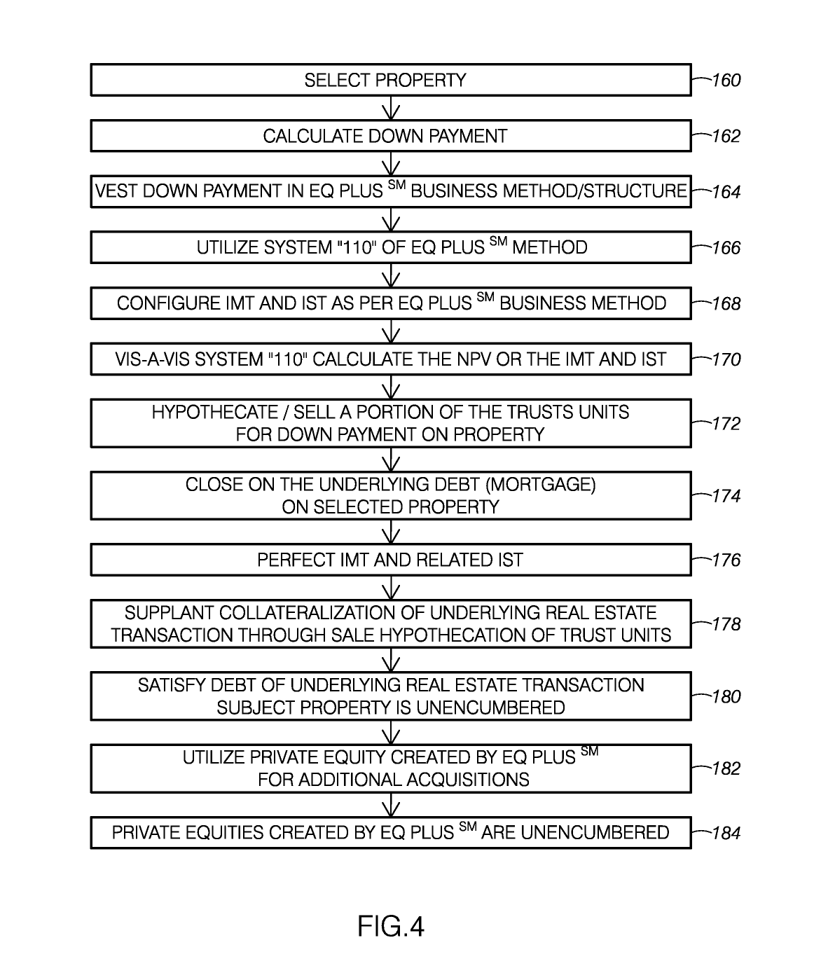

Referring now to FIG. 4, for illustrative purposes and convenience, the process steps will be described in conjunction with the exemplary system as shown in FIG. 1. The first step, 160 is to select the property to initiate the implementation of the system and methods of the present invention. The system of the present invention can compute a down payment in step 162 that will satisfy the requirements of the methods of the present invention. The system can account for several variables, including income stream of the subject property, tenant base, appraisal value, and necessary equity component required by a lending institution.

The down payment can be vested into the methods/financial structure of the present invention in step 164. In steps 166 through 170, the system can create an irrevocable master trust and sub-trust as described above. A portion of the trust units can be sold or hypothecated in step 172 for a down payment on the property and the underlying debt (mortgage) on the property can close in step 174.

To perfect the Irrevocable Master Trust and related Irrevocable Sub-Trusts in step 176 through the processes of FIGS. 1 through 3, described above. Sale or hypothecation of trust units, in step 178 can be performed to supplant collateralization of the underlying real estate transaction. In step 180, debt satisfaction may be achieved by way of hypothecating and/or selling a portion of the Private Equities (trust units) created by the methods of the present invention.

Once the debt is satisfied, in step 182, the private equity created by the system and methods of the present invention are available for additional acquisitions. Step 184 described how this private equity that is created is unencumbered.

The Business Method/SECP of the present invention can be utilized with either debt or equity components (hereinafter referred to as the “Vector”). The Vector is placed into an Irrevocable Master Trust for a determinate time interval. The Vector funds are typically invested into a “highly creditworthy” investment vehicle that has proven and demonstrable historical returns on investment (ROI). Various investment vehicles may be used for the Vector Component of the invention. These investment vehicles will be computationally analyzed by System 110 to ascertain their suitability for SECP.

The Vector funds are allowed to compound in the Time Determinate Irrevocable Master Trust over its lifetime. Therefore, based upon the projected returns of the highly “creditworthy” investment vehicle and the determinate lifetime of the Irrevocable Trust, one can compute by way of System 110, the Net Present Value (NPV) of the Trust. The NPV will be significantly more valuable than the Vector's Value. It is important to note that value in the Time Determinate Irrevocable Trust is created contemporaneously at the time of the closing of the underlying financial transaction. The net effect of utilizing the Business Method/SECP is transformative to the Vector Component since its value is increased significantly at closing of the financial transaction.

In the Time Determinate Irrevocable Master Trust, the debt or equity used to purchase the highly “creditworthy” investment vehicle(s) has proven and demonstrable historical returns. The selected investment vehicle(s) must have a positive return on investment under various economic conditions. The selection should be centered upon consistency of average annual returns for a period of not less than 7 years. Additionally, there should be a contractual agreement between the provider of the “creditworthy” investment vehicle and the trustee of the Time Determinate Master Irrevocable Trust. The agreement should be congruous in duration to the lifetime of the Irrevocable Master Trust. Additionally, the investment vehicle(s) should have sufficient averaged annual returns to generate a NPV over the lifetime of the Time Determinate Irrevocable Master Trust that will exceed the value of the Vector Component at closing of the financial transaction. The foregoing is further augmented by the selection criteria variables utilized by System 110 software as referenced below:

Alpha is a measure of the average return of an investment as compared to a benchmark, such as the S&P 500. Alpha is a risk-adjusted measure of the active return on an investment. Therefore, a strong and consistent alpha is a desired attribute of an investment. Beta is a measurement of volatility of an investment. The beta is compared to a benchmark, such as the S&P 500. In essence, one can characterize the beta as the tendency of an investment to respond to swings in the market. The less the propensity of an investment to swing under various economic conditions, the more secure and the more “credit worthy” the investment.

R-squared (R²) is a necessary statistic to factor into the equation when selecting the investment vehicle in the process of the present invention, as described above. R-squared reflects the percentage of an investments' movement that is explained by the corresponding movement of the benchmark index. Of course, if the selected investment vehicle consistently surpasses its benchmark, this investment would meet one element of the criteria selection process as described above with respect to FIG. 2.

Additionally, asset stress test software, such as Alternativesoft, should be utilized to determine, firsthand, whether the investment selection will perform well under various market conditions. This software will take into account the alpha, beta and R-squared characteristics of the investment vehicle. This software, or similar products, can be used to provide the asset stress return with probabilities of future returns notwithstanding previous performance as a sole basis for future asset performance.

To satisfy the need for asset divisibility in the Time Determinate Irrevocable Master Trust, the investment vehicle(s) contracts should be vested in the name of any Special Purpose Vehicle (SPV) that is divisible. The SPV can be a LLC with Membership Units, a Corporation with Shares, or the Corpus of the Time Determinate Master Trust can create “Trust Units”. The foregoing provides the user of SECP the liquidity that is needed to prevent a default without the entire liquidation of the assets held by the Time Determinate Irrevocable Master Trust. In essence, it allows the user of SECP to “carve out” a portion of the assets held by the Time Determinate Irrevocable Master Trust while preserving the value and integrity of the same.

Optionally, to further enhance the NPV of the Irrevocable Master Trust, the present invention can utilize an Irrevocable Sub-Trust (IST) to augment the already “creditworthy” historically proven investment vehicle(s). The IST can be drawn upon to compensate for less than average or negative annual returns. Additionally, the IST can be utilized for the purpose of increasing NPV of the IMT to extend the financial reach and scope of the IMT. The IST also serves as the Self-Insured Component (SIC) of the Invention. The SIC can be configured contemporaneously at the time of the closing of the underlying transaction. This element of the invention provides “instant” coverage against the default of the underlying transaction.

The components of the Business Method/SECP can be procured in a different time sequence to suit the needs of the user. For example, the selected income generating investment vehicle(s) may be chosen prior to the procurement of the Vector component. However, for the useful value of the Business Method/SECP to be realized, the components of SECP must be used in the prescribed sequence as depicted in the flowchart and contained herein.

Another significant element of the Business Method/SECP is the potential for element reconfiguration of the Time Determinate Irrevocable Trust. By increasing the lifetime of the Irrevocable Master Trust in conjunction with the Long Term Investment Contracts (LTIC), the user of the Business Method/SECP also increases the NPV of the Trust. Accordingly, the internal investment vehicle compounding of a Trust that has a five year lifespan will have lesser NPV in comparison to a Trust that has a ten year lifespan under the prescribed criteria of the invention utilizing System 110.

It should be understood, of course, that the foregoing relates to exemplary embodiments of the invention and that modifications may be made without departing from the spirit and scope of the invention as set forth in the following claims.

What is claimed is:

1. A computer assisted method for preventing default of a financial transaction comprising:
computationally analyzing one or more investment candidates to determine one or more suitable investments;
computing the net present value of the one or more suitable investments; and
creating contemporaneous liquidity upon execution of the financial transaction by vesting the one or more suitable investments into an irrevocable master trust that supports the financial transaction, wherein
the net present value of the one or more suitable investments created in the irrevocable master trust are separate from the financial transaction and have more value than the financial transaction.

2. The method of claim 1, further comprising carving out trust units to acquire a new long term investment contract and vesting the new long term investment contract into an irrevocable sub-trust.

3. The method of claim 2, wherein the new long term investment contract is analyzed computationally for determine a new set of one or more investment candidates to determine one or more suitable investments.

4. The method of claim 2, further comprising computing a second net present value of the irrevocable sub-trust.

5. The method of claim 4, further comprising adding a value of the irrevocable sub-trust to a value of the irrevocable master trust to compensate for less than projected returns or to extend financial reach and scope of the irrevocable master trust.

6. The method of claim 4, further comprising self-insuring the financial transaction by ensuring sufficient value of the irrevocable sub-trust.

7. A financial structure comprising:
an underlying financial transaction; and
an irrevocable master trust created contemporaneously upon execution of the underlying financial transaction to support the underlying financial transaction.

8. The financial structure of claim 7, further comprising carved out trust units to acquire a new long term investment contract, wherein the carved out trust units vests the new long term investment contract into an irrevocable sub-trust.

9. The financial structure of claim 8, wherein a net present value of the irrevocable sub-trust is added to a net present value of the irrevocable master trust to compensate for less than projected returns or to extend financial reach and scope of the irrevocable master trust.

10. The financial structure of claim 8, wherein a net present value of the irrevocable sub-trust operates as a self-insurance vehicle for the underlying financial transaction.

11. A system for preventing default of a financial transaction comprising:
a data storage device;
a control program; and
a data processor, wherein
the control program includes software configured for
computationally analyzing one or more investment candidates to determine one or more suitable investments;
computing the net present value of the one or more suitable investments; and
creating contemporaneous liquidity upon execution of the financial transaction by vesting the one or more suitable investments into an irrevocable master trust that supports the financial transaction, wherein
the net present value of the one or more suitable investments created in the irrevocable master trust are separate from the financial transaction and have more value than the financial transaction.

12. The system of claim 11, further comprising:
a data input device to provide input into the system; and
a data output device to allow a user to view data from the system.

13. The system of claim 11, wherein the data input device includes at least one of a keyboard, mouse, touchscreen, and voice recognition; and the data output device includes at least one of a video monitor and an audio output.

14. The system of claim 11, wherein the data storage device is hosted via cloud computing on a mainframe computing system.

15. The system of claim 11, wherein the software is further configured for carving out trust units to acquire a new long term investment contract and vesting the new long term investment contract into an irrevocable sub-trust.

16. The system of claim 15, wherein the software is further configured for analyzing the new long term investment contract to determine a new set of one or more investment candidates to determine one or more suitable investments.

17. The system of claim 15, wherein the software is further configured for computing a second net present value of the irrevocable sub-trust.

18. The system of claim 17, wherein the software is further configured for adding a value of the irrevocable sub-trust to a value of the irrevocable master trust to compensate for less than projected returns or for extending financial reach and scope of the irrevocable master trust.

19. The system of claim 17, wherein the software is further configured to permit a net present value of the irrevocable sub-trust to operate as a self-insurance vehicle for the financial transaction.
